(19) United States
(12) Patent Application Publication
(10) Pub. No.: US 2025/0298419 A1
(43) Pub. Date: Sep. 25, 2025

(54) AUTOMATED TRANSPORT SYSTEM, INFORMATION PROCESSING DEVICE, MOVING BODY, INFORMATION PROCESSING METHOD, AND STORAGE MEDIUM

(71) Applicant: Kabushiki Kaisha Toshiba, Tokyo (JP)

(72) Inventors: Akihiro MORI, Kawasaki (JP); Daisuke YAMAMOTO, Kawasaki (JP)

(73) Assignee: Kabushiki Kaisha Toshiba, Tokyo (JP)

(21) Appl. No.: 19/072,295

(22) Filed: Mar. 6, 2025

(30) Foreign Application Priority Data
Mar. 22, 2024 (JP) 2024-045865

(51) Int. Cl. G05D 1/644; G05D 1/667; G05D 1/69; G05D 101/15; G05D 105/20; G05D 107/70; G05D 109/10; G05D 111/10; G06T 7/70

(52) U.S. Cl. CPC G05D 1/644; G05D 1/667; G05D 1/69; G06T 7/70; G05D 2101/15; G05D 2105/20; G05D 2107/70; G05D 2109/10; G05D 2111/10; G06T 2207/20081; G06T 2207/30252

(57) ABSTRACT

According to an embodiment, there is provided an automated transport system having a plurality of automated transport bodies, a sensor, and a controller. The sensor acquires information on positions of objects in a work area. The controller controls the plurality of automated transport bodies. The controller includes a route information acquirer, a congestion degree evaluator, and an automated transport body selector. The route information acquirer acquires, for each of the plurality of automated transport bodies, route information that indicates a route along which the automated transport body travels to a transport source of a target object. The congestion degree evaluator evaluates a congestion degree distribution that indicates a degree of congestion of objects in the work area on the basis of information on positions of the objects. The automated transport body selector selects an automated transport body that will perform a transport operation from among the plurality of automated transport bodies on the basis of the route information and the congestion degree distribution.

### CROSS-REFERENCE TO RELATED APPLICATION(S)

This application is based upon and claims the benefit of priority from Japanese Patent Application No. 2024-045865, filed on Mar. 22, 2024; the entire contents of which are incorporated herein by reference.

### FIELD

An embodiment of the present invention relates to an automated transport system, an information processing device, a moving body, an information processing method, and a non-transitory computer readable storage medium that stores a program.

### BACKGROUND

In order to solve a labor shortage in logistics and manufacturing sites, a technique in which an automated transport body such as a movable robot transports a target object is known as one of the means for automating transport operations in distribution warehouses, factory facilities, and the like.

### BRIEF DESCRIPTION OF THE DRAWINGS

FIG. 1 is a schematic diagram showing an automated transport system according to a first embodiment.

FIG. 2 is a block diagram showing a system configuration of the automated transport system according to the first embodiment.

FIG. 3 is a schematic diagram showing a congestion degree distribution in a work area and a route set for each of the automated transport bodies in the first embodiment.

FIG. 4 is a flowchart showing a process flow of the automated transport system according to the first embodiment.

FIG. 5 is a schematic diagram showing an automated transport system according to a second embodiment.

FIG. 6 is a block diagram showing a system configuration of an automated transport system according to a third embodiment.

FIG. 7 is a block diagram showing a system configuration of an automated transport system according to a fourth embodiment.

### DETAILED DESCRIPTION

An automated transport system according to the embodiment is an automated transport system for transporting target objects within a work area. The automated transport system includes a plurality of automated transport bodies, a sensor, and a controller. The plurality of automated transport bodies transport the target objects from a transport source to a transport destination. The sensor acquires information on a position of an object in the work area. The controller controls the plurality of automated transport bodies. The controller includes a route information acquirer, a congestion degree evaluator, and an automated transport body selector. The route information acquirer acquires, for each of the plurality of automated transport bodies, route information indicating a route along which the automated transport body will travel to the transport source of the target object. The congestion degree evaluator evaluates a congestion degree distribution that indicates a degree of congestion of the objects in the work area on the basis of information about the positions of the objects. The automated transport body selector selects an automated transport body that will perform a transport operation among the plurality of automated transport bodies on the basis of the route information and the congestion degree distribution.

Hereinafter, an automated transport system, an information processing device, a moving object, an information processing method, and a storage medium according to embodiments will be described with reference to the drawings. The drawings are schematic or conceptual, and a relationship between a thickness and a width of each part, a size ratio between parts, and the like are not necessarily the same as those in reality. Even when the same part is shown, dimensions and ratios of each part may be different according to the drawing.

In this specification, the term “based on XX” means “based on at least XX,” and includes a case based on another element in addition to XX. In addition, the terms “based on XX” are not limited to a case in which XX is directly used, and also includes a case based on XX that has been calculated or processed. “XX” is any element (for example, information).

### First Embodiment

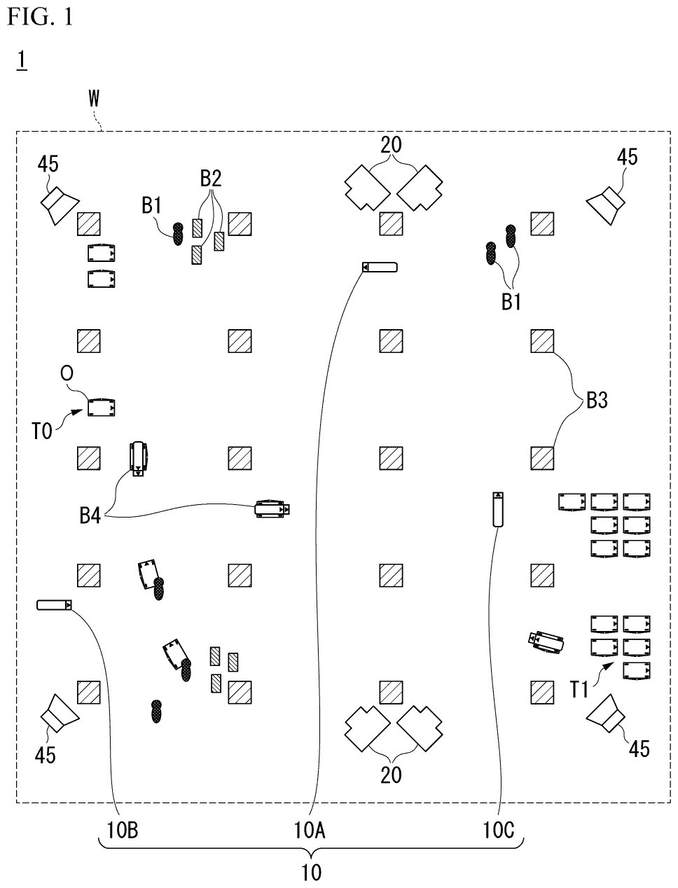

An automated transport system 1 according to a first embodiment will be described with reference to FIGS. 1 to 4.

First, a configuration of the automated transport system 1 will be described below with reference to FIGS. 1 to 3.

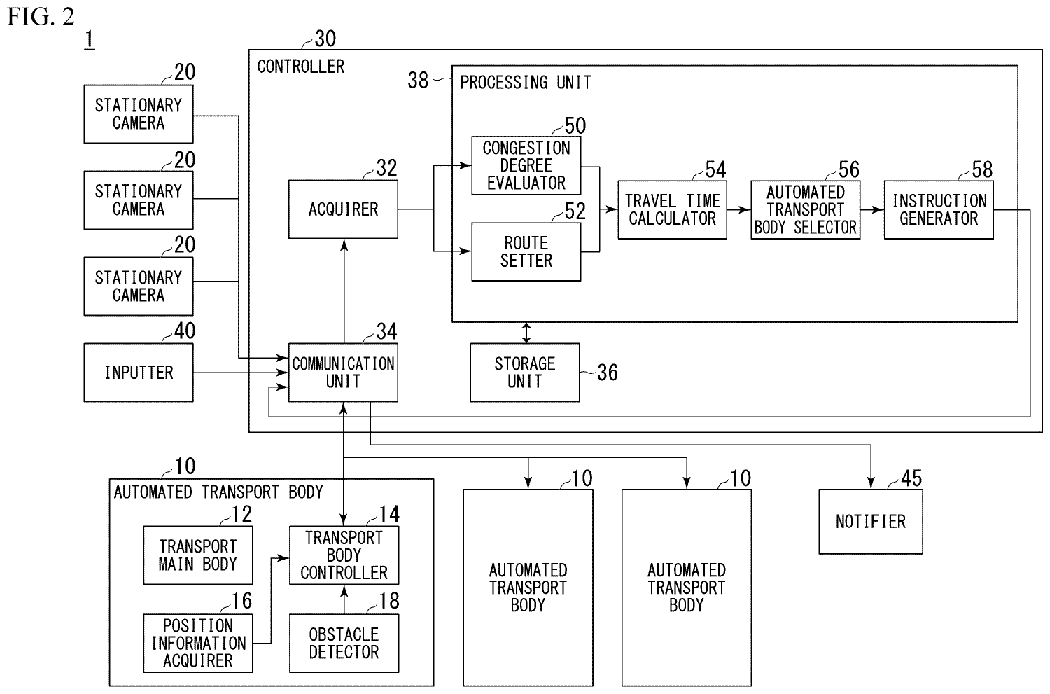

FIG. 1 is a schematic diagram showing the automated transport system 1. FIG. 2 is a block diagram showing a system configuration of the automated transport system 1.

As shown in FIGS. 1 and 2, the automated transport system 1 has a plurality of automated transport bodies 10 (10A to 10C), one or more stationary cameras 20, a controller 30, an inputter 40, and a notifier 45. The automated transport system 1 transports a target object O by the automated transport body 10 within a work area W. The work area W is not particularly limited, and may be, for example, a distribution warehouse, a factory facility, or a research laboratory. The target object O is not particularly limited, but may be a material, a commodity, a device, a luggage, a container, or the like. As shown in FIG. 1, in the work area W, in addition to the automated transport bodies 10 (in FIG. 1, three automated transport bodies 10A, 10B, and 10C) that are not performing transport operations, there are also a worker B1, temporary installations B2 (such as luggage), environmental structures B3 (such as pillars), and an automated transport body B4 that is working.

In response to a transport instruction, the automated transport body 10 first moves to a transport source T0 to load luggage, and then moves from the transport source T0 to a transport destination T1 to unload the luggage. For example, the luggage which is a target object O is sorted at the transport source TO according to a destination thereof and is loaded onto a cart. This loading onto the cart may be done manually or may use another automated loading system. In a case in which the loading of the luggage onto the cart is completed, a transport instruction is issued to the transport destination T1 corresponding to a destination among a plurality of destinations. The transport instruction includes position information of the transport source TO and the transport destination T1. The controller 30 receives this transport instruction, issues an instruction to each of the automated transport bodies 10, and controls the automated transport bodies 10 so that a transport operation proceeds efficiently throughout the entire work area W. The automated transport body 10 instructed by the controller 30 first moves to the transport source TO at which the cart loaded with luggage is located, is coupled to the cart, and then moves to the designated transport destination T1 while transporting the cart.

The form of the automated transport body 10 is not particularly limited, and may be any moving body. For example, the automated transport body 10 may be in the form of a vehicle, a movable robot having a means of movement such as wheels, caterpillar tracks, or walking legs, or may be in the form of a moving body guided by a guide unit such as a rail. The automated transport body 10 may be a flying object, but the following description will be directed to an automated transport body 10 that moves mainly on a floor surface.

As shown in FIG. 2, the automated transport body 10 includes a transport main body 12, a transport body controller 14, a position information acquirer 16, and an obstacle detector 18. The transport main body 12 can travel by any means. The transport body controller 14 controls movement of the transport main body 12. The transport body controller 14 can communicate with the controller 30 wirelessly or by wire via a communication unit (not shown) mounted in the automated transport body 10. The position information acquirer 16 uses any known means to identify position coordinates of the automated transport body 10. The obstacle detector 18 detects an obstacle that is present around the automated transport body 10. A specific means of the obstacle detector 18 is not particularly limited, and any known sensor such as a sonar sensor, an ultrasonic sensor, or an infrared sensor can be used.

The transport body controller 14 can control the transport main body 12 to stop or slow down in a case in which the obstacle detector 18 detects an obstacle. For example, in a case in which the obstacle detector 18 detects an obstacle ahead on a travel route, the transport body controller 14 can stop the transport main body 12 so that the transport main body 12 does not collide with the obstacle.

In the work area W, one or more stationary cameras 20 (an example of a “sensor”) are provided as optical sensors. A position of the stationary camera 20 is not particularly limited, but it is preferable that a plurality of stationary cameras 20 are installed so that, as a whole, they can capture as wide an area as possible within the work area W.

The stationary camera 20 acquires imaging data including images or videos of the work area W and transmits the imaging data wirelessly or via a wire to the controller 30. The imaging data may be transmitted from the stationary camera 20 to the controller 30 via another information processing device. The controller 30 can associate pixel positions in the imaging data with physical positions within the work area W on the basis of an installation position and a viewing angle of the stationary camera 20 and the imaging data of the stationary camera 20. In a case in which the plurality of stationary cameras 20 are installed, the controller 30 may aggregate the imaging data captured by each of the stationary cameras 20 to obtain image data of the entire work area W. The imaging data of the stationary camera 20 is an example of information on the positions of objects in the work area W (here, the “objects” includes people such as workers B1, objects temporarily installed in the work area W such as temporary installations B2, objects permanently installed in the work area W such as environmental structures B3, automated transport bodies B4 in operation, and automated transport bodies 10 that are not performing transport operations). The information on the positions of the objects can be used to recognize the positions of the objects in the work area W. The information on the positions of the objects is, for example, optically acquired information. One example of the optically acquired information is an image (including a video) of the work area W.

The controller 30 (not shown in FIG. 1) may be configured of one or more information processing devices. The controller 30 is provided at a position at which it can control the automated transport body 10 while being connected to the automated transport body 10 wirelessly or via a wire. The configuration of the controller 30 will be described below.

The inputter 40 receives instruction information including the transport instruction. For example, the inputter 40 receives an input operation of the transport instruction by a user. A method of inputting to the inputter 40 is not particularly limited. The inputter 40 may be mounted as a part of the controller 30.

In response to a signal from the controller 30, the notifier 45 outputs audio, images, or the like to the worker B1 in the work area W to notify the worker B1.

As shown in FIG. 2, the controller 30 includes, as functional parts thereof, an acquirer 32, a communication unit 34, a storage unit 36, and a processing unit 38. The acquirer 32 acquires information from the outside. The communication unit 34 communicates with the outside to receive a signal from the outside and transmit a signal to the outside. The storage unit 36 stores a variety of data including programs. The processing unit 38 performs various operation processes described below.

The acquirer 32 can acquire the imaging data received from the stationary camera 20 via the communication unit 34. The acquirer 32 can also acquire instruction information including a transport instruction received by the inputter 40.

The processing unit 38 includes a congestion degree evaluator 50, a route setter 52, a travel time calculator 54, an automated transport body selector 56, and an instruction generator 58 as functional parts thereof. By having these functional parts, the controller 30 can select the automated transport body 10 that is most suitable for the transport operation from among the plurality of automated transport bodies 10, taking into consideration a degree of congestion in the work area W. Hereinafter, the control process in the automated transport system 1 will be described through an explanation of each of the functional parts.

The congestion degree evaluator 50 evaluates the degree of congestion within the work area W on the basis of the imaging data acquired by the acquirer 32 from the stationary camera 20. Here, the “degree of congestion” is a quantity that represents a degree of congestion of objects, people, automated transport bodies, and the like that could become obstacles to the travel of the target automated transport bodies 10A to 10C at a certain position within the work area W. Moreover, the “obstacle” here refers to something that is physically present in the work area W and that may impede the travel of a target automated transport body in a case in which it moves at a certain time. In a case in which a travel route of the target automated transport body is set in advance in the work area W, the degree of congestion of obstacles that are present in the area including the travel route is recognized as the degree of congestion. The congestion degree evaluator 50 can evaluate the congestion degree distribution in which the degree of congestion is mapped for each of the positions within the work area W.

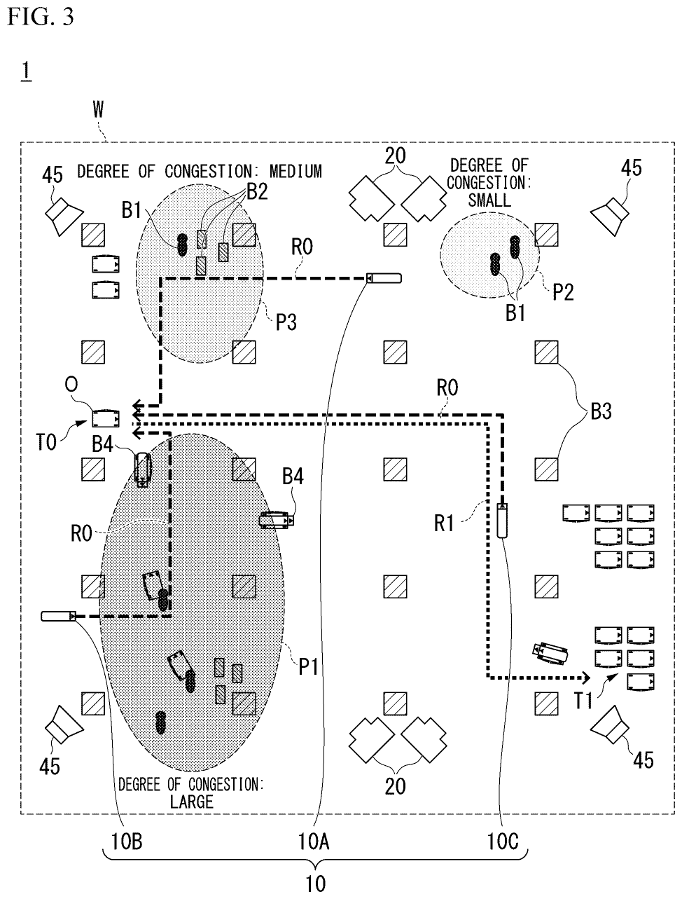

FIG. 3 is a schematic diagram showing the congestion degree distribution in the work area W and the routes R0 and R1 set for each of the automated transport bodies 10A to 10C. At a position P1, since there are many obstacles (any of B1 to B4), a congestion degree value is large. At a position P2, since there are relatively few obstacles (any of B1 to B4), the congestion degree value is small. The degree of congestion at a position P3 has a value approximately intermediate between the positions P1 and P2.

As a method for the congestion degree evaluator 50 to evaluate the degree of congestion, three types of methods will be specifically described here, but the method is not limited thereto.
(1) A method for evaluating the degree of congestion on the basis of an area of a floor surface
(2) A method for evaluating the degree of congestion on the basis of object recognition on the floor surface
(3) A method for evaluating the degree of congestion using a trained model due to machine learning

In the method (1), the congestion degree evaluator 50 recognizes the floor surface of the work area W from the imaging data acquired from the stationary camera 20, and evaluates the size of the floor surface. For example, the congestion degree evaluator 50 can combine the imaging data captured by each of the stationary cameras 20 to generate image data of the entire work area W and thus can recognize the floor surface within the work area W. Then, the congestion degree evaluator 50 compares a size of the floor surface under normal circumstances stored in the storage unit 36 with a size of the floor surface evaluated from the imaging data, and calculates a concealment rate of the floor surface. Here, the “concealment rate of the floor surface” refers to a proportion of a portion of the floor surface that is not exposed per unit area of the floor surface. The congestion degree evaluator 50 can assume that an obstacle is present at a portion at which the floor surface is not exposed, and can determine the concealment rate of the floor surface at each position in the work area W as the degree of congestion at that position. The congestion degree evaluator 50 can obtain a distribution in which the concealment rate of the floor surface is mapped to each position on the floor surface as the congestion degree distribution. The congestion degree evaluator 50 may determine a value obtained by performing any operation process on the concealment rate of the floor surface as the degree of congestion.

In the method (2), the congestion degree evaluator 50 recognizes non-stationary objects (for example, a worker B1, a temporary installation B2, an automated transport body B4 in operation, and the like) that are temporarily present within the work area W from the imaging data acquired from the stationary camera 20. Here, the “non-stationary object” refers to an object (which may be a person) that can change a position thereof within the work area W, is temporarily located at a certain position, and is movable from there. For example, the congestion degree evaluator 50 can combine the imaging data captured by each of the stationary cameras 20 to generate image data of the entire work area W and can recognize the non-stationary objects within the work area W. The congestion degree evaluator 50 compares a size of the floor surface under normal conditions stored in the storage unit 36 with an area occupied by the non-stationary objects to calculate an occupancy rate of the non-stationary objects. Here, the “occupancy rate of the non-stationary objects” refers to a proportion of an area occupied by the non-stationary objects per unit area of the floor surface. Ideally, the concealment rate of the floor surface coincides with the occupancy rate of the non-stationary objects. The congestion degree evaluator 50 can regard the non-stationary objects as obstacles and may determine the occupancy rate of the non-stationary objects at each position in the work area W as the degree of congestion at that position. The congestion degree evaluator 50 can obtain a distribution in which the occupancy rate of the non-stationary objects is mapped to each position on the floor surface as the congestion degree distribution. The congestion degree evaluator 50 may determine a value obtained by performing any calculation process on the occupancy rate of the non-stationary objects as the degree of congestion. The congestion degree evaluator 50 may evaluate the degree of congestion with an occupancy rate of objects including not only the non-stationary objects but also stationary objects that cannot change their position within the work area W, such as the environmental structures B3.

In the method (3), the congestion degree evaluator 50 uses a trained model that has learned a relationship between the imaging data of the work area W and the congestion degree distribution, and outputs the congestion degree distribution within the work area W in response to input of the imaging data (or processed data thereof) obtained from the stationary camera 20. A learning method of the trained model is not particularly limited, and any known method such as deep learning can be used. The trained model may be trained in advance and stored in the storage unit 36.

The congestion degree evaluator 50 may not only evaluate the congestion degree distribution at a certain point in time, but also acquire the congestion degree distribution that changes over time in real time. Furthermore, the congestion degree evaluator 50 may predict the congestion degree distribution after a predetermined time on the basis of a change over time of the congestion degree distribution. For example, the congestion degree evaluator 50 can recognize the movement (for example, a movement direction and a movement speed) of each of the non-stationary objects in the work area W and can predict a position of the object after a predetermined time. The congestion degree evaluator 50 may calculate the position of each of the objects after a predetermined time assuming that the movement direction and movement speed of each of the objects will be maintained, or may predict the movement of the object using any known algorithm or machine learning. The congestion degree evaluator 50 can predict the congestion degree distribution after a predetermined time by predicting the position of each of the objects after the predetermined time for all the non-stationary objects.

In this way, the congestion degree evaluator 50 can automatically evaluate the congestion degree distribution from the imaging data without requiring an input from the outside (for example, a user or another information processing device) regarding the position of the non-stationary objects or the degree of congestion thereof which are not managed by the system.

The route setter 52 (an example of a “route information acquirer”) sets routes R0 and R1 for transporting a target object O within the work area W for each of the automated transport bodies 10. Specifically, the route setter 52 acquires a current position of each of the automated transport bodies 10, a current position of the target object O (that is, a position of the transport source TO), and a position of the transport destination T1 of the target object O, and sets, for each of the automated transport bodies 10, the route R0 from the current position to the transport source TO and the route R1 from the transport source T0 to the transport destination T1. The current position of each of the automated transport bodies 10 can be acquired by the position information acquirer 16 of the automated transport body 10 and can be transmitted from the transport body controller 14 to the controller 30. The position information of the transport source TO and the transport destination T1 can be included in the transport instruction acquired by the acquirer 32.

The route setter 52 can set a different route R0 for each of the automated transport bodies 10 for the route R0 from the current position to the transport source TO, while setting a common route R1 for all the automated transport bodies 10 for the route R1 from the transport source T0 to the transport destination T1. However, the route setter 52 may set a different route R1 for each of the automated transport bodies 10.

The route setter 52 may set a route arbitrarily on the floor surface of the work area W, or may set a route along a predetermined reference route within the work area W. For example, the reference route may be a route that passes through a travel path provided for the automated transport body 10 on the floor surface, or may be a route that follows a rail on the floor surface. In a case in which the reference route is used, the route setter 52 can set the route according to the predetermined reference route without the need to calculate the route. The route setter 52 can set, for example, a route along which the automated transport body 10 can travel from a starting position to a destination position in the shortest distance. In a case in which there are a plurality shortest routes, the route setter 52 may select and set one of the shortest routes on the basis of any criteria (for example, so that an accumulated value of the degree of congestion at a position through which the route passes is minimized), or may set all of the plurality of shortest routes as candidate routes.

The travel time calculator 54 calculates a time required for each of the automated transport bodies 10 to travel from the current position to the transport source TO along the route R0. The travel time calculator 54 also calculates a time required for each of the automated transport bodies 10 to travel from the transport source T0 to the transport destination T1 along the route R1. Hereinafter, a time required for the automated transport body 10 to travel from one position to another will be referred to as a “travel time.” For example, the travel time calculator 54 can calculate a travel time for each of the routes of the automated transport body 10 using basic information such as a travel speed profile of each of the automated transport bodies 10 stored in the storage unit 36.

The travel time calculator 54 can calculate the travel time of the automated transport body 10 taking into consideration the congestion degree distribution calculated by the congestion degree evaluator 50. For example, in a case in which the travel time of the automated transport body 10 is calculated, the travel time calculator 54 can correct the calculation so that the travel time of the automated transport body 10 is slower in a section on the route in which the degree of congestion is high. The method of correcting the calculation is not particularly limited. For example, the travel time calculator 54 may add a stop time according to the degree of congestion to the travel time for a section in which the degree of congestion is greater than a predetermined value, or may multiply the travel time by a coefficient that is inversely correlated with the degree of congestion (for example, a coefficient that is inversely proportional to the degree of congestion).

In a case in which the congestion degree evaluator 50 predicts a change over time of the congestion degree distribution, the travel time calculator 54 can calculate the travel time of the automated transport body 10 taking into consideration the prediction of the congestion degree distribution. For example, the travel time calculator 54 predicts the position of the automated transport body 10 at each time using information on the route set by the route setter 52 and basic information such as the travel speed profile of each of the automated transport bodies 10 stored in the storage unit 36. In order to take into consideration the predicted degree of congestion, the travel time calculator 54 can compare the information on the predicted position of the automated transport body 10 at each time with the predicted congestion degree distribution at each time. For example, in a case in which the degree of congestion at the predicted position of the automated transport body 10 is large (for example, larger than a predetermined threshold value), the travel time calculator 54 predicts a change over time of the position of the automated transport body 10, assuming that the automated transport body 10 will stop at the predicted position until the congestion is relieved, and that the automated transport body 10 will resume the travel at the time in a case in which the degree of congestion at the predicted position becomes sufficiently small (for example, becomes smaller than a predetermined threshold value). In this way, the travel time calculator 54 can calculate the travel time taking into consideration future changes in the degree of congestion. The calculation method is not limited to the above example.

The automated transport body selector 56 selects the automated transport body 10 that is most suitable for transporting the target object O. For example, the automated transport body selector 56 can compare the travel times of the automated transport bodies 10 calculated by the travel time calculator 54 to select the automated transport body 10 that will transport the target object O. Specifically, the automated transport body selector 56 can select the automated transport body 10 that has the shortest travel time. In a case in which the travel time calculator 54 calculates the travel time for a plurality of routes, the automated transport body selector 56 can select the route with the shortest travel time. In a case in which the route is selected, the automated transport body 10 is automatically selected. However, it is not necessary to select the automated transport body 10 with the shortest travel time, and the automated transport body selector 56 may select the automated transport body 10 to transport the target object O by taking into consideration not only the travel time but also other conditions. Here, the travel time used as the criterion for selecting the automated transport body 10 may be the travel time from the current position of the automated transport body 10 to the transport source TO, may be a total travel time required for the automated transport body 10 to travel from the current position to the transport source TO and then from the transport source T0 to the transport destination T1, or may be a travel time for any other section.

The automated transport body 10 selected in consideration of the degree of congestion as described above does not necessarily have to have the shortest length of the route R0 from the current position to the transport source TO. In other words, the automated transport body selector 56 can select the automated transport body 10 that is most suitable for transporting the target object O without having to identify the automated transport body 10 closest to the target object O or the shortest route to the target object O. Furthermore, the automated transport body selector 56 can automatically select the most suitable automated transport body 10 without the need for human judgment. For example, as shown in FIG. 3, among the waiting automated transport bodies 10A, 10B, and 10C, the automated transport body 10B has the shortest distance from the current position thereof to the transport source TO, followed by the automated transport body 10A with the next shortest distance, and the automated transport body 10C with the longest distance. However, in a case in which the congestion degree distribution shown in FIG. 3 is taken into consideration, it is expected that the automated transport body 10C which has no congestion between the current position and the transport source TO can travel most efficiently. Therefore, the automated transport body selector 56 can select the automated transport body 10C as the automated transport body 10 that transports the target object O.

However, the method of selecting the automated transport body 10 is not limited to the above example. For example, the automated transport body selector 56 may select the automated transport body 10 for transporting the target object O on the basis of information about the route of each of the automated transport bodies 10 and the degree of congestion on the route, without the need to calculate the travel time. Specifically, the automated transport body selector 56 may add up the degrees of congestion on the routes set by the route setter 52 for each of the automated transport bodies 10, and may select the automated transport body 10 with the smallest sum of the degrees of congestion as the automated transport body 10 to transport the target object O. In a case in which the degrees of congestion on the route are added up, the automated transport body selector 56 may calculate the degrees of congestion for each position on the route at a predicted time in a case in which the automated transport body 10 is to pass, taking into consideration the change over time of the degree of congestion, and then may add up them. The automated transport body selector 56 may select an automated transport body 10 to transport the target object O, taking into consideration other conditions such as a length of the route of each of the automated transport bodies 10 in addition to the degree of congestion.

The instruction generator 58 generates a travel instruction indicating a travel route of the automated transport body 10. For example, the instruction generator 58 generates a travel instruction including information on the route R0 from the current position of the automated transport body 10 selected by the automated transport body selector 56 to the transport source TO and the route R1 from the transport source T0 to the transport destination T1. The controller 30 transmits the travel instruction to the selected automated transport body 10 via the communication unit 34. The transport body controller 14 of the automated transport body 10 controls the transport main body 12 to travel within the work area W in accordance with the received travel instruction.

Furthermore, the instruction generator 58 generates a notification instruction for causing the notifier 45 to notify a predetermined alert. Specifically, in a case in which the congestion degree distribution or the state of the automated transport body 10 satisfies a predetermined condition, the instruction generator 58 can generate the notification instruction to cause the notifier 45 to issue an alert to relieve the congestion. For example, in a case in which there is a position on the route that is highly congested, the instruction generator 58 generates a notification instruction to cause the notifier 45 to issue an alert to relieve the congestion at that position. Alternatively, in a case in which the instruction generator 58 determines that there is an automated transport body 10 that has been waiting for a long time due to congestion in the work area W, the instruction generator 58 generates an instruction to cause the notifier 45 to issue an alert to relieve the congestion on the travel route of the automated transport body 10. For example, in a case in which the number of times that the automated transport body 10 located closest to the transport source TO has not been selected by the automated transport body selector 56 exceeds a predetermined number of times, or in a case in which a waiting time of the automated transport body 10 exceeds a predetermined time, the instruction generator 58 can determine that there is an automated transport body 10 that has been waiting for a long time, and can generate an instruction to cause the notifier 45 to issue an alert to relieve the congestion on the travel route of the automated transport body 10. Alternatively, in a case in which the degree of congestion on the route of each of the automated transport bodies 10 is greater than a predetermined threshold value, the instruction generator 58 can generate an instruction to cause the notifier 45 to issue an alert to relieve the congestion on the route. Additionally, specific conditions for issuing an alert are not particularly limited. The alert to relieve the congestion is not particularly limited and includes an alert instructing the worker B1 on the route to move away, an alert instructing the worker B1 to remove temporary installations B2 on the route, and the like.

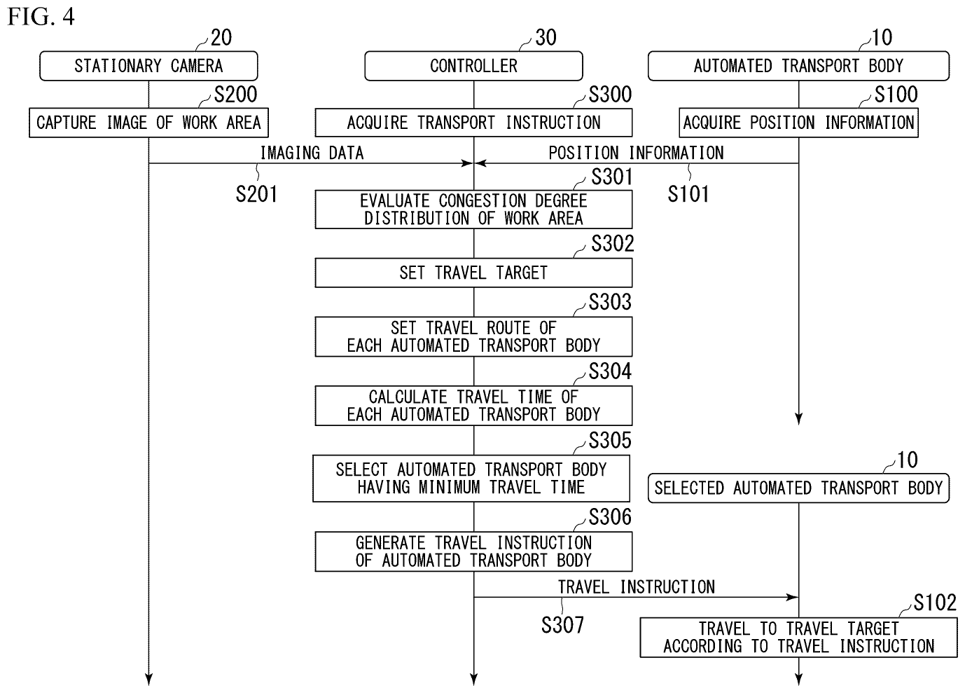

Next, a flow of control of the automated transport body 10 by the automated transport system 1 will be described with reference to FIG. 4.

FIG. 4 is a flowchart showing a flow of processing in the automated transport system 1.

In Step S100, the position information acquirer 16 of each of the automated transport bodies 10 acquires position information of the automated transport body 10. In Step S101, the transport body controller 14 of each of the automated transport bodies 10 transmits the acquired position information to the controller 30. Although FIG. 4 shows that the automated transport body 10 acquires and transmits position information only once, these operations may be performed continuously.

In Step S200, the stationary camera 20 captures an image of the work area W. In Step S201, the stationary camera 20 transmits imaging data to the controller 30. Although FIG. 4 shows that the stationary camera 20 captures and transmits images only once, these operations may be performed continuously.

In Step S300, the acquirer 32 acquires a transport instruction from the inputter 40. In Step S301, the congestion degree evaluator 50 evaluates the congestion degree distribution in the work area W on the basis of the imaging data acquired from the stationary camera 20. In Step S302, the route setter 52 sets the positions of the travel targets (the transport source TO and the transport destination T1) on the basis of the acquired transport instruction. In Step S303, the route setter 52 sets a travel route R0 for each of the automated transport bodies 10 to reach the transport source TO on the basis of the position information of the automated transport body 10. The route setter 52 can also set a travel route R1 from the transport source T0 to the transport destination T1. In Step S304, the travel time calculator 54 calculates the travel time of each of the automated transport bodies 10 on the basis of the congestion degree distribution evaluated in Step S301 and the travel route set in Step S303. In Step S305, the automated transport body selector 56 selects the automated transport body 10 that has the shortest travel time calculated in Step S304 as the automated transport body 10 that will transport the target object O. In Step S306, the instruction generator 58 generates a travel instruction for the automated transport body 10 selected in Step S305 to travel to the transport source TO. The instruction generator 58 can also generate a travel instruction for the selected automated transport body 10 to travel from the transport source T0 to the transport destination T1. In Step S307, the controller 30 transmits the travel instruction generated in Step S306 to the automated transport body 10 selected in Step S305. In Step S102, the selected automated transport body 10 travels to the transport source T0, which is the travel target, in accordance with the received travel instruction. In a case in which the automated transport body 10 also receives a travel instruction from the transport source T0 to the transport destination T1, the automated transport body 10 loads the target object O at the transport source T0, and then travels to the transport destination T1 which is the next travel target in accordance with the travel instruction to the transport destination T1.

According to the automated transport system 1 of the first embodiment, in a case in which transportation using the automated transport body 10 such as a mobile robot is automated at a logistics site or manufacturing site, the automated transport body 10 can be selected so that it can travel while avoiding congestion as much as possible.

In order to explain the advantages of the automated transport system 1 in detail, a conventional automated transport system will first be outlined. In conventional automated transport technology, the allocation of a mobile robot to perform a next transport operation was often on the basis of a state in which the mobile robot is performing a transport operation, an estimated time until completion of a current operation, and a travel distance to the transport source. However, since it is difficult to secure a space dedicated to mobile robots at logistics and manufacturing sites, mobile robots often travel and transport objects in shared spaces that are also used by workers. Therefore, in a case in which there are workers in a space on the planned route of the mobile robot and congestion occurs, the mobile robot may have to wait, which may reduce the overall transport efficiency.

On the other hand, the automated transport system 1 according to the first embodiment can take into consideration the degree of congestion on the transport route as a criterion for selecting an automated transport body that will perform the transport in response to a transport request. Thus, since the automated transport body 10 that is unlikely to cause a long waiting time due to congestion can be preferentially selected, the waiting time of the automated transport body 10 can be shortened. By evaluating the degree of congestion in the work area W on the basis of the imaging data of the non-stationary objects such as workers B1 and temporary installations B2, which are factors outside the jurisdiction of the transport system, the optimal automated transport body 10 can be selected in accordance with the actual congestion. In this way, the efficiency of automated transport can be improved.

### Second Embodiment

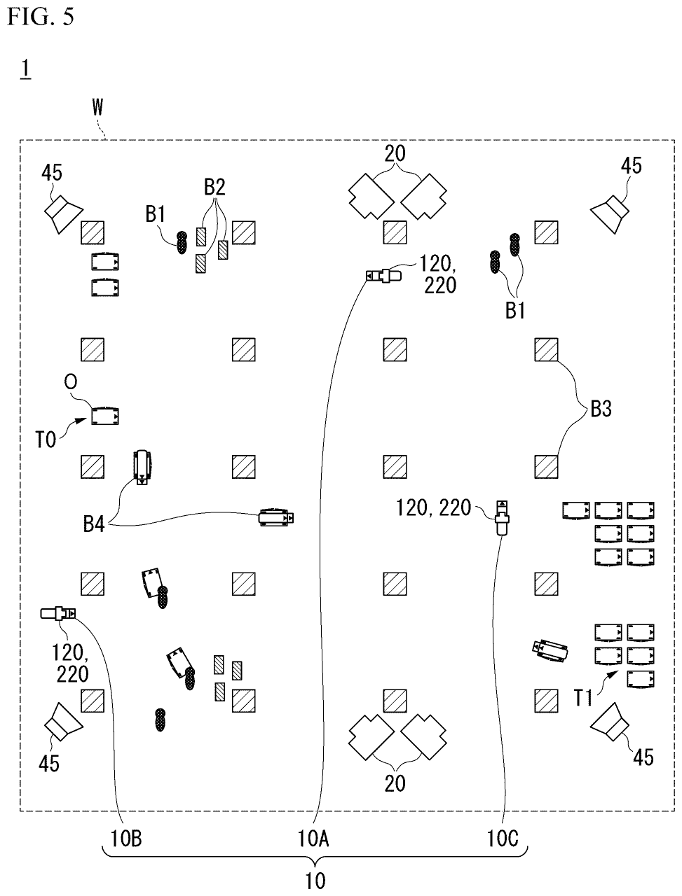

An automated transport system 1 according to a second embodiment will be described with reference to FIG. 5. The second embodiment is different from the first embodiment in that an automated transport body 10 is selected on the basis of data acquired by a transport body camera 120 and/or an optical scanner 220 mounted on the automated transport body 10. The following mainly describes the differences from the above embodiment and does not repeat the description of the points in common with the above embodiment.

FIG. 5 is a schematic diagram showing the automated transport system 1 according to the second embodiment.

In the second embodiment, as shown in FIG. 5, each of the automated transport bodies 10 is equipped with the transport body camera 120 and/or the optical scanner 220 as an optical sensor.

The transport body camera 120 (an example of a “sensor”) is a camera mounted on the transport main body 12. Each of the automated transport bodies 10 can capture images of surroundings thereof using the transport body camera 120 while it is traveling or stopped. Imaging data (an example of “information on a position of an object”) captured by the transport body camera 120 is transmitted from the transport body controller 14 to the controller 30.

The congestion degree evaluator 50 can evaluate the congestion degree distribution in the work area W using the imaging data captured by the transport body camera 120 obtained from the automated transport body 10. Specifically, the congestion degree evaluator 50 can recognize positions of objects in the work area W by aggregating the imaging data of the transport body cameras 120 of the automated transport bodies 10. The congestion degree evaluator 50 may evaluate the degree of congestion of the work area W with only the imaging data captured by the transport body camera 120, but since the field of view of the transport body camera 120 of each of the automated transport bodies 10 alone may be limited, it is preferable to use both the imaging data captured by the stationary camera 20 and the imaging data captured by the transport body camera 120. The stationary camera 20 captures an image of the entire work area W, but there may be cases in which a blind spot of the stationary camera 20 occurs due to the non-stationary objects or environmental structures B3. The transport body camera 120 is mounted on the self-propelled automated transport body 10 and thus can compensate for the blind spot of the stationary camera 20. Therefore, by the congestion degree evaluator 50 using the image data captured by the stationary camera 20 and the image data captured by the transport body camera 120 in combination, the blind spot in the image recognition of the work area W for the purpose of evaluating the degree of congestion can be reduced.

The optical scanner 220 (an example of a “sensor”) is an optical surveying sensor mounted on the transport main body 12. The optical scanner 220 can obtain point group data of the work area W by radiating light onto surrounding objects and detecting reflected light. Any known optical scanner can be used as the optical scanner 220. The point group data (an example of “information on a position of an object”) acquired by the optical scanner 220 is transmitted from the transport body controller 14 to the controller 30.

The congestion degree evaluator 50 can evaluate the congestion degree distribution of the work area W using the point group data of the optical scanner 220 acquired from the automated transport body 10. Specifically, the congestion degree evaluator 50 can aggregate the point group data from the optical scanners 220 of each of the automated transport bodies 10 and can recognize the positions of objects including people in the work area W. The congestion degree evaluator 50 may evaluate the congestion degree of the work area W with only the point group data of the optical scanner 220, but as in the transport body camera 120, since there may be cases in which the field of view of the optical scanner 220 of each of the automated transport bodies 10 alone is limited, it is preferable to use both the imaging data of the stationary camera 20 and the point group data of the optical scanner 220. The optical scanner 220 is mounted on the self-propelled automated transport body 10 as in the transport body camera 120, and thus can compensate for blind spots of the stationary camera 20. In addition to (or instead of) being mounted on the automated transport body 10, the optical scanner 220 may be fixed in the work area W in the same manner as the stationary camera 20.

Only one of the transport body camera 120 and the optical scanner 220 may be mounted on the automated transport body 10, or both may be mounted on the automated transport body 10. The congestion degree evaluator 50 may evaluate the congestion degree distribution of the work area W on the basis of the imaging data of the transport body camera 120 and the point group data of the optical scanner 220 without the stationary camera 20.

According to the second embodiment, information on portions of the work area W that cannot be adequately captured by the stationary camera 20 alone can be obtained by the transport body camera 120 and/or the optical scanner 220 mounted on the self-propelled automated transport body 10. Thus, the accuracy of the congestion degree evaluator 50 in evaluating the congestion degree distribution can be improved.

### Third Embodiment

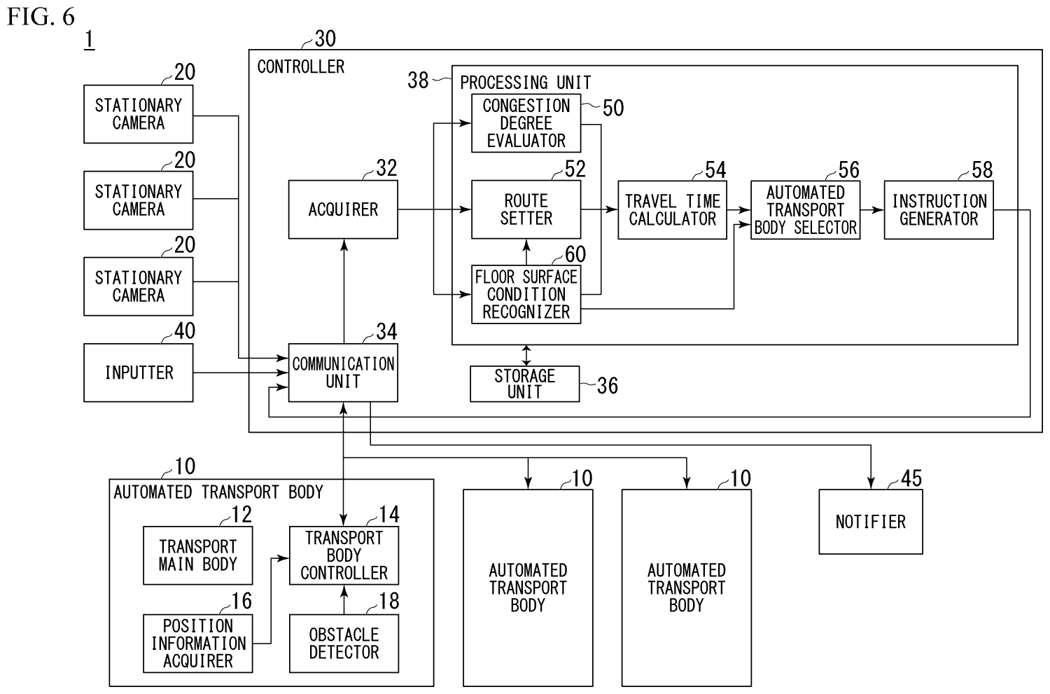

An automated transport system 1 according to a third embodiment will be described with reference to FIG. 6. The third embodiment is different from the first embodiment in that the processing unit 38 includes a floor surface condition recognizer 60, and the travel time calculator 54 calculates the travel time by taking into consideration the recognition result of the floor surface condition recognizer 60. The following mainly describes the differences from the above embodiment and does not repeat the description of the points in common with the above embodiment.

FIG. 6 is a block diagram showing a system configuration of the automated transport system 1 according to the third embodiment.

In the third embodiment, as shown in FIG. 6, the processing unit 38 of the controller 30 includes the floor surface condition recognizer 60.

The floor surface condition recognizer 60 can recognize the condition of the floor surface in the work area W on the basis of information on the positions of objects, such as the imaging data of the stationary camera 20, the imaging data of the transport body camera 120, and the point group data of the optical scanner 220. For example, the floor surface condition recognizer 60 detects abnormality such as wetness or soiling of the floor surface from images of the floor surface contained in various types of imaging data.

The information on the abnormality detected by the floor surface condition recognizer 60 can be used in one or more of the route setter 52, the travel time calculator 54, and the automated transport body selector 56. For example, the route setter 52 can set a route so as to avoid the abnormality on the floor surface. In a case in which the route passes through an abnormal portion of the floor surface, the travel time calculator 54 can correct the travel time through the abnormal portion (for example, so that a longer travel time than normal is required). The automated transport body selector 56 can exclude an automated transport body 10 that passes over the abnormality on the floor surface from selection targets.

According to the third embodiment, the information on the positions of objects acquired by various sensors such as the stationary camera 20 can be used not only to evaluate the congestion degree distribution but also to recognize a condition of a travel path of the automated transport body 10. Thus, it is possible to set the route of the automated transport body 10 and to select the automated transport body 10 to perform the transportation taking into consideration the abnormality on the floor surface.

### Fourth Embodiment

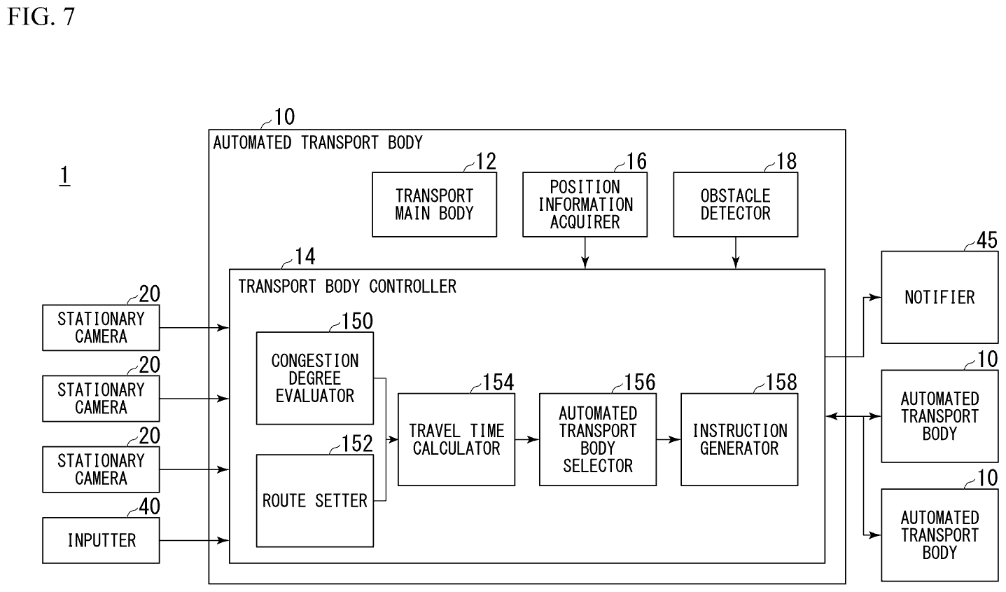

An automated transport system 1 according to a fourth embodiment will be described with reference to FIG. 7. The fourth embodiment is different from the first embodiment in that the transport body controller 14 of the automated transport body 10 performs the functions of the controller 30 instead of the controller 30. The following mainly describes the differences from the above embodiment and does not repeat the description of the points in common with the above embodiment.

FIG. 7 is a block diagram showing a system configuration of the automated transport system 1 according to the fourth embodiment.

As shown in FIG. 7, the automated transport body 10 (an example of a “moving body”) of the fourth embodiment has a transport main body 12 (an example of a “moving main body”), a transport body controller 14 (an example of a “moving body controller”), a position information acquirer 16, and an obstacle detector 18, as in the first embodiment. The transport body controller 14 is connected directly or indirectly to the stationary camera 20 and the inputter 40 wirelessly or via a wire. In addition, the transport body controllers 14 of the respective automated transport bodies 10 are connected to each other directly or indirectly wirelessly or via a wire.

The transport body controller 14 includes a congestion degree evaluator 150, a route setter 152, a travel time calculator 154, an automated transport body selector 156, and an instruction generator 158. These functional parts perform the same processes as the congestion degree evaluator 50, the route setter 52, the travel time calculator 54, the automated transport body selector 56, and the instruction generator 58 included in the controller 30 in the above embodiment, respectively. Specifically, the transport body controller 14 acquires information on the positions of objects in the work area W (for example, imaging data of the work area W) from the stationary camera 20, and acquires a transport instruction or information on a transport target from the inputter 40. The congestion degree evaluator 150 evaluates the congestion degree distribution of the work area W on the basis of the information on the positions of objects. The route setter 152 sets a route for transporting a target object O (specifically, a route R0 from the current position of the automated transport body 10 to the transport source T0 and a route R1 from the transport source T0 to the transport destination T1) on the basis of the transport instruction or the transport target information acquired from the inputter 40 and the position information of the automated transport body 10 itself acquired by the position information acquirer 16. The automated transport body selector 156 selects an automated transport body 10 that will transport the target object O from among the plurality of automated transport bodies 10 on the basis of the set route and the congestion degree distribution. In this embodiment, since the automated transport body selector 156 is provided on each of the automated transport bodies 10, it can also be said that the automated transport body selector 156 determines whether or not the automated transport body 10 provided by itself will perform the transport operation of the target object O. The instruction generator 158 generates an instruction for the selected automated transport body 10 to transport the target object O along the route on the basis of the processing result of the automated transport body selector 156.

In the above example, since the example in which the transport body controller 14 of the automated transport body 10 performs a series of processes has been described, the controller 30 is not shown in FIG. 7, but it goes without saying that the controller 30 may be provided separately. The overall control method for the plurality of automated transport bodies 10 is not particularly limited. For example, each of the plurality of automated transport bodies 10 may be centrally controlled by the controller 30, or the automated transport bodies 10 may autonomously cooperate with each other through communication therebetween without the intervention of the controller 30, or one or more specific automated transport bodies 10 among the plurality of automated transport bodies 10 may control the other automated transport bodies 10.

Hereinafter, modified examples of the above embodiment will be described.

The controller 30 may be implemented using a single information processing device (such as a personal computer), or may be implemented by distributed processing of a plurality of information processing devices. For example, some or all of the functional parts of the controller 30 may be implemented by a cloud server or the like. In addition, in the first to third embodiments, the examples in which the controller 30 performs all of the congestion evaluation, the route setting, the automated transport body selection, and the instruction generation have been described, and in the fourth embodiment, the example in which the transport body controller 14 performs all of the above processes has been described, but the controller 30 and the transport body controller 14 may perform distributed processing. For example, the controller 30 may perform the congestion evaluation, the automated transport body selection, and the instruction generation, and the transport body controller 14 of each of the automated transport bodies 10 may perform the route setting for each of the automated transport bodies 10. However, a method of dividing the processes in the distributed processing is not limited to the above example. Also, the distributed processing may be performed among the plurality of automated transport bodies 10.

In the above embodiment, it has been described that the congestion degree evaluator 50 evaluates the congestion degree distribution and then the route setter 52 sets the route, but the order is not particularly limited. The congestion degree evaluator 50 may evaluate the congestion degree distribution after the route setter 52 sets the route, or the processing of the congestion degree evaluator 50 and the processing of the route setter 52 may be performed in parallel.

In each of the above embodiments, the processing in the controller 30 is assumed to be realized by program software in an external storage device such as a memory using one or more processors such as a central processing unit (CPU), but may also be realized by hardware (for example, a circuit unit; circuitry) that does not use the CPU. The processing may also be performed via a cloud server.

The instructions shown in the processing procedures shown in each of the embodiments can be performed on the basis of a program which is software. A general-purpose calculator system can obtain the same effects as those of the processing procedures described above by reading a program stored in advance. The instructions described in each of the embodiments are recorded as a program that can be executed by an information processing device such as a computer on a magnetic disk (a flexible disk, a hard disk, or the like), an optical disk (CD-ROM, CD-R, CD-RW, DVD-ROM, DVD+R, DVD+RW, Blu-ray (registered trademark) Disc, or the like), a semiconductor memory, or a similar non-transitory computer-readable recording medium. The storage format may be any type as long as the storage medium is a computer- or embedded system-readable recording medium. The computer can realize operations similar to the above-described processing procedures by reading the program from this recording medium and having the CPU execute the instructions described in the program on the basis of this program. The computer may obtain or load the program through a network.

According to at least one of the embodiments described above, the congestion degree distribution within the work area W can be evaluated on the basis of the information on the positions of objects, such as the imaging data and the point group data of the work area W, and the automated transport body 10 can be selected on the basis of the congestion degree distribution, thereby improving transport efficiency.

A hardware configuration for realizing each of the above-described software functional parts will now be described.

The above-described configurations such as the acquirer 32, the communication unit 34, the storage unit 36, the processing unit 38, and the inputter 40 are functional parts realized by cooperation of a hardware configuration including a processor, a memory, a storage, an input/output IF, an communication IF, and buses that connect them to each other.

The processor is hardware that processes commands written in data and a program. The processor is configured of, for example, a control device, an operation device, and a register.

The memory is hardware that temporarily stores programs and data. For example, the memory is a volatile memory such as static random access memory (SRAM) or dynamic random access memory (DRAM).

The storage is hardware that stores programs and data. For example, the storage is a non-volatile memory such as a flash memory, a hard disk drive (HDD), or a ferroelectric memory.

The input/output IF functions as an interface with an input device that receives input operations from a user, or the like, and an output device that presents information to the user. Examples of the input device include a pointing device such as a mouse or a touch panel, and a keyboard. The output device includes a display, a speaker, and the like.

The communication IF is an interface that inputs and outputs a signal for communicating with an external device.

Although several embodiments of the present invention have been described, these embodiments are presented as examples and are not intended to limit the scope of the invention. These embodiments can be implemented in various other forms, and various omissions, substitutions, and modifications can be made without departing from the gist of the invention. These embodiments and modifications thereof are included in the scope of the invention and equivalents thereof as described in the claims, as well as in the scope and gist of the invention.

What is claimed is:

1. An automated transport system which transports a target object within a work area, comprising:
a plurality of automated transport bodies configured to transport the target object from a transport source to a transport destination;
a sensor configured to acquire information on a position of an object in the work area; and
a processor configured to control the plurality of automated transport bodies,
wherein the processor is configured to:
acquire, for each of the plurality of automated transport bodies, route information that indicates a route along which the automated transport body travels to a transport source of the target object;
evaluate a congestion degree distribution that indicates a degree of congestion of objects in the work area on the basis of the information on the positions of the objects; and
select an automated transport body that will perform a transport operation from among the plurality of automated transport bodies on the basis of the route information and the congestion degree distribution.

2. The automated transport system according to claim 1, wherein the sensor includes a stationary camera provided in the work area, and
the information on the positions of the objects includes image data of the work area acquired by the stationary camera.

3. The automated transport system according to claim 1, wherein the sensor includes a transport body camera mounted on each of the plurality of automated transport bodies, and
the information on the positions of the objects includes image data of the work area acquired by the transport body camera.

4. The automated transport system according to claim 1, wherein the sensor includes an optical scanner mounted on each of the plurality of automated transport bodies, and
the information on the positions of the objects includes point group data of the work area acquired by the optical scanner.

5. The automated transport system according to claim 1, wherein the processor is further configured to recognize a floor surface of the work area from the information on the positions of the objects, and evaluate the congestion degree distribution on the basis of an exposed area of the floor surface.

6. The automated transport system according to claim 1, wherein the processor is further configured to recognize objects in the work area from the information on the positions of the objects, and evaluate the congestion degree distribution on the basis of a degree of space occupation by the objects.

7. The automated transport system according to claim 1, wherein the processor is further configured to output the congestion degree distribution from the information on the positions of the objects acquired by the sensor, using a trained model that has learned a relationship between the information on the positions of the objects and the congestion degree distribution.

8. The automated transport system according to claim 1, wherein the route is a predetermined reference route within the work area.

9. The automated transport system according to claim 1, wherein the processor is further configured to:
calculate, for each of the plurality of automated transport bodies, a required time for the automated transport body to travel to the transport source of the target object on the basis of the route information and the congestion degree distribution, and
select an automated transport body having a shortest required time from among the plurality of automated transport bodies as an automated transport body that will perform a transport operation.

10. The automated transport system according to claim 1, wherein the processor is further configured to select an automated transport body having a minimum degree of congestion on a route from among the plurality of automated transport bodies, on the basis of the route information and the congestion degree distribution, as an automated transport body that will perform a transport operation.

11. The automated transport system according to claim 1, wherein the processor is further configured to:
predict a change over time of the congestion degree distribution, and
select an automated transport body that will perform a transport operation from among the plurality of automated transport bodies, on the basis of the route information and the predicted change over time of the congestion degree distribution.

12. The automated transport system according to claim 1, wherein the processor is further configured to:
detect an abnormality on the floor surface by recognizing a condition of the floor surface of the work area on the basis of the information on the positions of the objects, and
select an automated transport body that will perform a transport operation from among the plurality of automated transport bodies, on the basis of the congestion degree distribution, the route information, and a recognition result of the floor surface condition.

13. The automated transport system according to claim 1, further comprising a notifier configured to issue an alert to relieve congestion on the route,
wherein the processor is further configured to instruct the notifier to issue the alert in a case in which the congestion degree distribution or a state of the automated transport body satisfies a predetermined condition.

14. The automated transport system according to claim 1, wherein the object includes at least one of a person, an object temporarily installed in the work area, an object permanently installed in the work area, and the plurality of automated transport bodies.

15. An information processing device for controlling a plurality of automated transport bodies that transport a target object from a transport source to a transport destination in an automated transport system for transporting the target object within a work area, comprising a processor configured to:
acquire, for each of the plurality of automated transport bodies, route information that indicates a route along which the automated transport body travels to a transport source of the target object;
evaluate a congestion degree distribution that indicates a degree of congestion of objects in the work area on the basis of information on positions of objects in the work area acquired by a sensor provided in the work area; and
select an automated transport body that will perform a transport operation from among the plurality of automated transport bodies on the basis of the route information and the congestion degree distribution.

16. A moving body configured as one of a plurality of automated transport bodies in an automated transport system including the plurality of automated transport bodies that transport a target object from a transport source to a transport destination within a work area, comprising:
a moving main body; and
a moving body controller,
wherein the moving body controller includes a processor configured to:
acquire route information that indicates a route along which the automated transport body travels to a transport source of the target object;
evaluate a congestion degree distribution that indicates a degree of congestion of objects in the work area on the basis of information on positions of objects in the work area acquired by a sensor provided in the work area; and
select an automated transport body that will perform a transport operation from among the plurality of automated transport bodies on the basis of the route information and the congestion degree distribution.

17. An information processing method for controlling a plurality of automated transport bodies that transport a target object from a transport source to a transport destination in an automated transport system for transporting the target object within a work area, comprising:
acquiring, for each of the plurality of automated transport bodies, route information that indicates a route along which the automated transport body travels to a transport source of the target object;
evaluating a congestion degree distribution that indicates a degree of congestion of objects in the work area on the basis of information on positions of objects in the work area acquired by a sensor provided in the work area; and
selecting an automated transport body that will perform a transport operation from among the plurality of automated transport bodies on the basis of the route information and the congestion degree distribution.

18. A non-transitory computer readable storage medium which stores a program for causing an information processing device to execute the method according to claim 17.
